(19) United States
(12) Patent Application Publication
(10) Pub. No.: US 2026/0048418 A1
(43) Pub. Date: Feb. 19, 2026

(54) MACHINE AND METHOD FOR SEPARATING WOOD-BASED MATERIALS FROM OTHER MATERIALS

(71) Applicant: PAL S.R.L., Ponte di Piave (TV) (IT)

(72) Inventors: Michele Libralato, Quinto Di Treviso (TV) (IT); Antonio Dal Ben

(73) Assignee: PAL S.R.L., Ponte di Piave (TV) (IT)

(21) Appl. No.: 19/101,556

(22) PCT Filed: May 12, 2023
(86) PCT No.: PCT/IT2023/050125

§ 371 Date: Feb. 5, 2025

(30) Foreign Application Priority Data
Aug. 5, 2022 (IT) 102022000016842

(51) Int. Cl. B07C 5/36; B07C 5/34

(52) U.S. Cl. CPC B07C 5/368; B07C 5/34; B07C 2501/0036

(57) ABSTRACT

Separation machine (10) for separating wood-based materials from other materials, comprising: feed means (24) that convey the materials (A) on the conveyor belt (11) with which there is associated a detection unit (14) configured to detect the presence of materials of organic origin and/or metallic materials; a plurality of compressed air nozzles (12a), disposed downstream of an outlet end (13) of such conveyor belt (11) and configured to selectively push said materials downward; and a blowing device (25) for blowing air towards the wood-based materials coming from said outlet end (13) pushing them beyond a separation element (18) disposed downstream of said blowing device (25).

### FIELD OF THE INVENTION

The present invention concerns the separation of wood-based materials, such as wood pieces, wood shavings, or wood flakes, also called “chips”, from other non-wood materials, such as plastic materials, rubbers, metallic materials, or inert materials, such as glass, stones, rocks, or pieces of brick, which is a preliminary operation to the production of wood-based panels.

### BACKGROUND OF THE INVENTION

In the field of wood-based panels, such as particle board (PB), MDF, OSB, the treatment of the wood flow in the so-called “green” zone of the plant is an essential step for the next phase of the actual production of the panels, including drying, gluing, forming and pressing.

In particular, in the aforementioned “green” zone, recycled wood requires more cleaning steps, to eliminate mainly metal pollutants and inert materials.

In patent application WO-A-2018211545 a separation machine is disclosed for separating wood-based materials from other materials, in which the woody material to be cleaned enters an inlet section, is deposited on a conveyor belt and accelerated by it so as to have substantially a monolayer of material without overlapping objects, to allow recognition by an optical system.

The machine also includes sensors configured to recognize any metal bodies in the flow by imparting a signal to a processing system to activate at least one or more air nozzles included at the position of the object detected on the belt. The flow of compressed air delivered by the nozzles deflects the foreign body downwards by dropping it into a collection section immediately following the outlet end of the objects from the conveyor belt.

The optical system allows the activation of the same nozzles once material of organic origin such as plastics and rubbers has been detected, which are always diverted and expelled in said section.

The material then, after undergoing a first selection and cleaning by the nozzles, due to the high speed of the conveyor belt, continues its trajectory through air, maintaining a height close to that of the belt surface for a horizontal stretch long enough to allow selection with a blower blowing air. In this way, similarly to the method used by kinetic air separators with a belt feed, the lighter residual material, i.e. wood, is pushed forward, bypassing a separation element, thus allowing heavier residual materials such as rocks and glass to fall into said collection section.

The blower is adjustable in air flow, inclination, height and position along the machine axis, to allow adaptation to the selection of flows of wood differing in density and humidity and different belt speeds, which entail different trajectories of the output flow. The speed of the belt is connected to the flow rate of material processed by the machine, always with the constraint of the singularity of the pieces to allow reading by the optical system.

One of the limitations of this machine is that the compressed air delivery nozzles are located at a certain distance from the blowing means, whereby the size of the machine can become relevant and also the efficiency of the selection of materials can be improved.

Therefore, such a machine, besides being relatively cumbersome, does not allow the selection with even greater precision and efficiency of the objects or materials that are in particular affected by the compressed air flow supplied by said nozzles.

There is therefore a need to perfect a machine and a separation method for separating wood-based materials from other materials which can overcome at least one of the disadvantages of the state of the art.

In particular, a purpose of the present invention is to provide a separation machine for separating wood-based materials from other materials that is capable of simultaneously and efficiently, effectively and reliably selecting various types of materials.

Another purpose of the present invention is to provide a separation machine that is compact and allows more fractions of materials to be selected than is the case in the known machines.

A further purpose of the present invention is to provide an effective and simple method for separating wood-based materials from other materials.

The Applicant has devised, tested and embodied the present invention to overcome the shortcomings of the state of the art and to obtain these and other purposes and advantages.

### SUMMARY OF THE INVENTION

The present invention is set forth and characterized in the independent claims. The dependent claims describe other characteristics of the present invention or variants to the main inventive idea.

In accordance with the above purposes, a separation machine according to the present invention for separating wood-based materials from other materials comprises: feed means that convey the materials on a conveyor belt with which there is associated a detection unit configured to detect the presence of materials of organic origin and/or metallic materials; a plurality of compressed air nozzles, disposed downstream of an outlet end of said conveyor belt and configured to selectively push said materials downwards; and a blowing device for blowing air towards the wood-based materials from said outlet end pushing them beyond a separation element disposed downstream of said blowing device.

In accordance with one aspect of the present invention, said separation machine comprises a collection zone, positioned between said separation element and said blowing device, for materials selected by said nozzles positioned near said blowing device and configured to give said selected materials a sufficient inertia to avoid being pushed by said blowing device.

In the present separation machine, there is advantageously provided a collection zone placed between said separation element and said blowing device, and said plurality of nozzles is positioned in proximity to said blowing means, making the machine extremely compact, efficient and able to select more fractions of materials than is the case in the known machines.

In accordance with another aspect of the present invention, said nozzles are positioned along a collector located above said blowing device and aligned with it in a substantially vertical direction.

In accordance with another aspect of the present invention, said collector comprises a support along which said nozzles are aligned.

In accordance with another aspect of the present invention, said support is shaped so that said nozzles deliver compressed air according to a direction inclined with respect to a longitudinal plane of said collector.

In accordance with another aspect of the present invention, each of said nozzles is fed by its own valve that works at a pressure greater than the pressure of the air blown by said blowing device.

In accordance with another aspect of the present invention, said separation machine comprises an additional plurality of nozzles configured to send the selected materials into an additional collection zone, and which are located downstream of said outlet end and upstream of said nozzles positioned in proximity to said blowing device.

In accordance with another aspect of the present invention, said further nozzles are positioned along a collector.

In accordance with another aspect of the present invention, said collectors, through said respective nozzles, deliver compressed air in diverging directions.

In accordance with another aspect of the present invention, said collectors are positioned specularly with respect to a substantially vertical plane.

A further object of the present invention is a method for separating wood-based materials from other materials, comprising: a step of loading, by means of feed means, the totality of materials to be separated onto a conveyor belt; a step of detecting, by means of a detection unit associated with said conveyor belt, the presence of materials of organic origin and/or of metallic materials from the materials to be separated; a step of selecting the materials by means of at least one plurality of compressed air nozzles and by means of a blowing unit, wherein said nozzles are disposed downstream of an outlet end of said conveyor belt and configured to selectively push downward, by means of compressed air, said materials of organic origin and/or said metallic materials detected by said detection unit, under the control of an electronic control unit, which processes the signals coming from said detection unit, and wherein said blowing device is configured to blow air toward the wood-based materials coming from said outlet end, which pass above said blowing device by inertia, and to push them beyond a separation element disposed downstream of said blowing device; and a step of collecting the materials selected by said nozzles in a collection zone located between said separation element and said blowing device, wherein said nozzles are positioned in the proximity of said blowing device, and are configured to give said selected materials sufficient inertia to avoid the thrust of said blowing device.

### DESCRIPTION OF THE DRAWINGS

These and other aspects, characteristics and advantages of the present invention will become apparent from the following description of some embodiments, given as a non-restrictive example with reference to the attached drawings wherein:

FIG. 1 is a schematic side view of a separation machine according to the present invention;

FIG. 2 is an axonometric view of a compressed air nozzle collector;

FIG. 2a is a larger scale view of a part of the collector of FIG. 2;

FIG. 3 is a larger scale view of a part of the separation machine of FIG. 1.

We must clarify that in the present description the phraseology and terminology used, as well as the figures in the attached drawings also as described, have the sole function of better illustrating and explaining the present invention, their function being to provide a non-limiting example of the invention itself, since the scope of protection is defined by the claims.

To facilitate comprehension, the same reference numbers have been used, where possible, to identify identical common elements in the drawings. It is understood that elements and characteristics of one embodiment can be conveniently combined or incorporated into other embodiments without further clarifications.

### DESCRIPTION OF SOME EMBODIMENTS OF THE PRESENT INVENTION

Reference will now be made in detail to the possible embodiments of the invention, of which one or more examples are illustrated in the accompanying figures by way of non-limiting example. The phraseology and terminology used herein is also for non-limiting exemplary purposes.

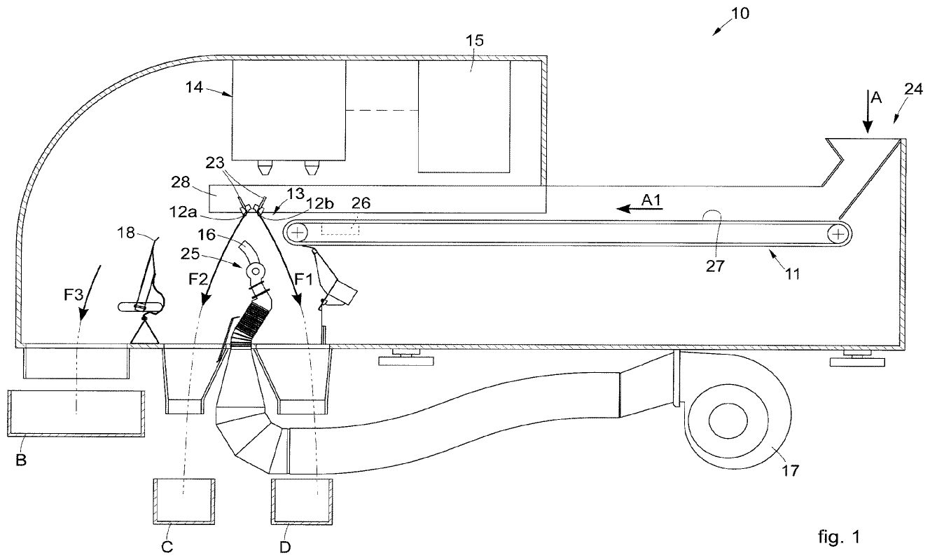

With reference to the attached drawings, see in particular FIG. 1, a separation machine 10 for separating wood-based materials from other materials, comprises: a conveyor belt 11 and feed means 24 configured to collect and convey the totality of materials A to be separated on said conveyor belt 11; a detection unit 14 associated with said conveyor belt 11 and configured to detect the presence of materials of organic origin and/or metallic materials from said materials A to be separated; a plurality of compressed air nozzles 12a, disposed downstream of an outlet end 13 of said conveyor belt 11 and configured to selectively push downward, by compressed air, said materials of organic origin and/or said metallic materials detected by said detection unit 14, under the control of an electronic control unit 15 that processes the signals coming from said detection unit 14; and a blowing device 25 configured to blow air towards the wood-based materials coming from said outlet end 13, which pass above it by inertia and push them beyond a separation element 18 disposed downstream of said blowing device 25.

The material to be separated is then loaded by said feed means 24 onto a support surface 27 of the conveyor belt 11 and translated in direction Al towards said outlet end 13.

Said separation machine 10 comprises a collection zone C of the materials selected from said nozzles 12a, i.e. at least the fraction F2, located between said blowing device 25 and said separation element 18. Said nozzles 12a are positioned in proximity to said blowing device 25 and configured to give the selected materials sufficient inertia to avoid the thrust, in particular from below and forward, of said blowing device 25.

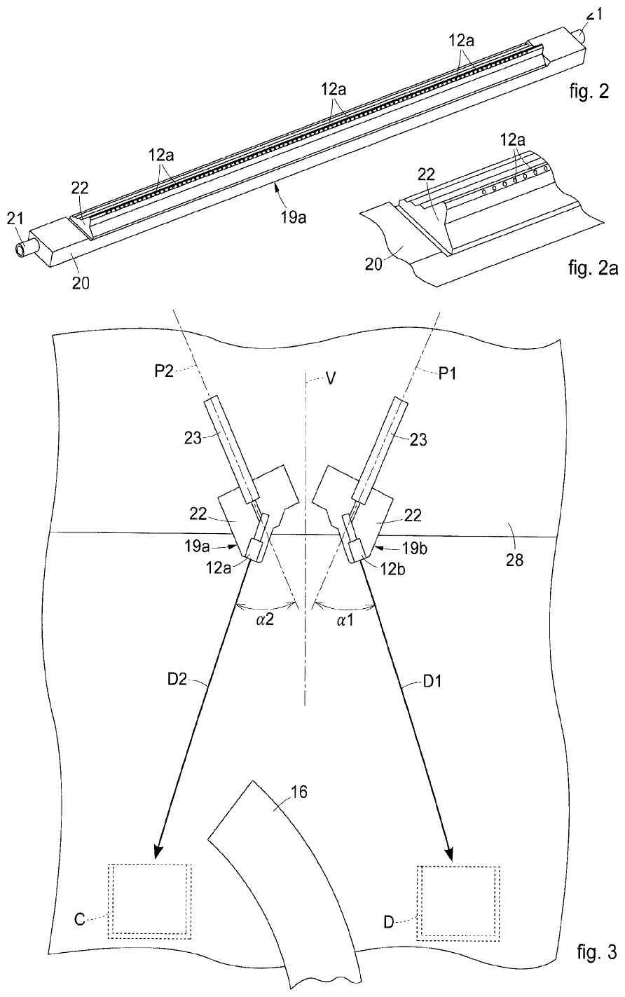

Said nozzles 12a are positioned along a collector 19a, see also FIGS. 2, 2a, located above said blowing device 25 and aligned with it in a substantially vertical direction.

Said collector 19a comprises a box body 20 provided at the ends with compressed air inlet openings 21, coming from a suitable feed source.

Said collector 19a comprises a support 22, in particular positioned on said box body 20, along which said nozzles 12a are aligned. Said support 22 is shaped so that said nozzles 12a deliver compressed air in a direction D2, see also FIG. 3, inclined by an angle a2 with respect to a longitudinal plane P2 of the collector 19a. Such an angle a2 may be any angle between 0°and 90°, for example about 45°or otherwise.

Each of said nozzles 12a is fed by its own valve 23, for example a pneumatic valve. Each valve 23 is connected to said electronic control unit 15 which regulates its opening and closing based on the signals coming from said detection unit 14.

Said valves 23 operate at a pressure comprised between about 6 and about 10 bar, preferably between 6 and 8 bar and with air flow rates comprised between about 90 and about 400 Nl/min.

Said detection unit 14 may be of the optical type and comprise NIR cameras, lights or similar.

Said detection unit 14 is able to detect the passage of material of organic origin, such as plastic materials, rubbers, wood derivatives, or the like, for example MDF panels, HPL panels, plastic or melamine coated chipboards. Said detection unit 14 is also capable of detecting inert materials such as glass, rocks, or similar.

Said detection unit 14 may also comprise a plurality of inductive sensors 26 of a type known per se, disposed just below the support plane 27 of the conveyor belt 11, and configured to detect the passage of metallic material, both ferrous and non-ferrous. Additionally or alternatively to said inductive sensors 26, an X-ray scanner for metals and inert materials can be provided under the support surface 27 of the conveyor belt 11, with a source disposed above the scanner and aligned with it.

For example, when the detection unit 14 detects the presence of a material of organic origin, through the cameras, or metal, through the inductive sensors 26, it sends a corresponding signal to the electronic control unit 15 which activates the corresponding valve 23 connected to a plurality of nozzles 12b, which with the compressed air push the detected material, i.e. the fraction F1, downward into an underlying first collection zone D.

Said nozzles 12b are located downstream of said outlet end 13 and upstream of said nozzles 12a, located in the vicinity of said blowing device 25.

Downstream of said nozzles 12b and substantially below said nozzles 12a, is disposed the outlet of said blowing device 25, comprising a blower 16 connected to a fan 17. Said blowing device 25 is configured to constantly, or selectively, blow air at a certain pressure, for example from about 0.005 bar to about 0.02 bar

The pressure at which the valves 23 of each of said nozzles 12a work, which as said can be comprised between about 6 bar and about 10 bar, is therefore decidedly higher than the blowing pressure of the air from said blowing device 25. Therefore, the thrust of compressed air from said nozzles 12a downwards is able to overcome the air blowing towards the other by said blowing device 25.

The blowing device 25 is configured to effect, by blowing air, the separation of the wood-based material, which has a relatively low specific weight, from the inert materials, such as for example stones, rocks and glass, which have a higher specific weight, which have not been detected by the detection unit 14. In fact, the selected wood-based elements leaving the conveyor belt 11, i.e. the fraction F3, will be blown beyond said separation element 18 and will be thrown relatively further than the inert materials and, after passing the separation element 18, will fall into said collection zone B.

Advantageously, in the present separation machine 10, said collection zone C is also provided, located between said separation element 18 and said blowing device 25, so that it is possible to further divide the material that does not pass beyond said separation element 18 into two collection zones, namely said collection zone C and said collection zone D.

Said nozzles 12b are positioned along a further collector 19b, FIG. 3, preferably the same as said collector 19a.

The support 22 of said collector 19b is shaped so that said nozzles 12b deliver compressed air according to a direction D1 inclined by an angle al with respect to a longitudinal plane P1 of said collector 19b. This angle al may be any angle between 0°and 90°, for example about 45°or otherwise.

Said collectors 19a and 19b are positioned specularly with respect to a substantially vertical plane V. In particular, said collectors 19a and 19b may suitably be fixed to a frame 28 of the separation machine 10.

Said collectors 19a and 19b, by means of the respective nozzles 12a and 12b, deliver compressed air in said diverging, and preferably specular, directions D2 and D1 with respect to said plane V.

Said direction D2 may be inclined with respect to said plane V by an angle comprised between about 0°and about 40°. The direction D1 may also be inclined with respect to the plane V by an angle comprised between about 0°and about 40°.

The supply of compressed air from above downward in said directions D2 and D1 allows a further separation of materials with respect to the known machines, although in the case of fraction F2 the material must overcome the thrust of the blowing device 25; this occurs because the thrust from above of the compressed air coming out of said nozzles 12a gives the objects a sufficient inertia to avoid the thrust from below and forward of the blowing device 25, which blows air at low pressure by means of the fan 17; this applies both to heavy bodies such as metals and to light bodies such as plastics, rubbers, or MDF and PB panels.

The operation of said nozzles 12a and/or of said nozzles 12b is defined at a software level and regulated by said electronic control unit 15, by associating

certain classes of materials with said nozzles 12a and other classes of materials with said nozzles 12b. For example, if the detection unit 14 recognizes a certain class of objects associated with said nozzles 12a, when said nozzles 12a are passed under said nozzles, one or more of said nozzles 12a will be activated to push said objects, i.e. the fraction F2, into the collection zone C.

By way of example, by means of this separation machine 10 it is possible to obtain the following fractions F1, F2 and F3 of selected materials:

Fraction F1: plastics, rubbers, MDF, associated with said nozzles 12b and therefore with the collector 19b;

Fraction F2: inert materials (glass, stones), metals (stainless steel, aluminium, wood with metal staples, copper), associated with said nozzles 12a and therefore with the collector 19a;

Fraction F3: wood, associated with said blowing device 25.

Other examples of fractions F1, F2 and F3 obtainable by the present separation machine 10 are: a first fraction F1 with materials based on MDF panel, a second fraction F2 with materials based on PB panel and a third fraction F3 of solid wood.

The present separation machine 10, with said three collection zones B, C, D, therefore allows a more precise and meticulous separation of the various materials, compared to the known machines.

The separation method for separating wood-based materials from other materials comprises, for example, a step of loading the material to be separated into said feed means 24, so that it falls on an underlying support plane of the conveyor belt 11. Said conveyor belt 11 can move the material to be separated in the direction A1 at a high conveying speed, for example from about 5 to 8 m/s, so that it is arranged substantially on a single layer, without overlapping the different pieces, thus obtaining a so-called singularization of the pieces themselves, to allow the optimal recognition of these by the detection unit 14. Then follows a detection step, wherein the detection unit 14 detects the possible presence of materials of organic origin and metallic materials. In a subsequent separation step, the actual separation is carried out, which takes place both by means of the selective activation of the nozzles 12a and possibly 12b, which cause the separation of the aforementioned materials of organic origin and of the metallic materials, which are pushed downwards into the collection zone C and possibly into the collection zone D, and by means of the air blowing from the blower device 25, which pushes only the wood-based material beyond the separation element 18, into the collection zone B, while the inert materials fall into the underlying collection zone C and possibly in the collection zone D.

It is clear that modifications and/or additions of parts or phases can be made to the separation machine and to the separation method as described heretofore, without departing from the field of the present invention as defined by the claims. It is also clear that, although the present invention has been described with reference to some specific examples, a person of skill in the art will be able to achieve other equivalent forms of a machine and method for separating wood-based materials from other materials, having the characteristics as set forth in the claims and hence all coming within the field of protection defined thereby.

In the following claims, the sole purpose of the references in brackets is to facilitate their reading and they must not be considered as restrictive factors with regard to the field of protection defined by the claims.

1. A machine for separating wood-based materials from other materials, comprising: feed means which convey the materials on a conveyor belt with which there is associated a detection unit configured to detect the presence of materials of organic origin and/or metallic materials; a plurality of compressed air nozzles, disposed downstream of an outlet end of said conveyor belt and configured to selectively push said materials downward; and a device for blowing air toward the wood-based materials coming from said outlet end pushing them beyond a separation element disposed downstream of said blowing device wherein said blowing device comprises a collection zone, located between said separation element and said blowing device, for collecting the materials selected by said nozzles which are positioned in proximity of said blowing device and are configured to give said selected materials sufficient inertia to avoid the thrust of said blowing device.

2. The separation machine of claim 1, wherein said nozzles are positioned along a collector located above said blowing device and aligned with it in a substantially vertical direction.

3. The separation machine of claim 2, wherein said collector comprises a support along which said nozzles are aligned.

4. The separation machine of claim 3, wherein said support is shaped so that said nozzles deliver compressed air in a direction inclined with respect to a longitudinal plane of said collector.

5. The separation machine of claim 1, wherein each of said nozzles is fed by its own valve which works at a pressure higher than the pressure of the air blown by said blowing device.

6. The separation machine of claim 1, wherein it comprises an additional plurality of nozzles configured to send the selected materials into an additional collection zone, and which are located downstream of said outlet end and upstream of said nozzles positioned in proximity of said blowing device.

7. The separation machine of claim 1, wherein said additional nozzles are positioned along a collector.

8. The separation machine of claim 2, wherein said collectors by means of said respective nozzles deliver compressed air in diverging directions.

9. The separation machine of claim 2, wherein said collectors are positioned specularly with respect to a substantially vertical plane.

10. The method for separating wood-based materials from other materials, comprising: a step of loading, by means of feed mean, the totality of materials on a conveyor belt a step of detecting, by means of a detection unit, the presence of materials of organic origin and/or of metallic materials to be separated; a step of selecting the materials by means of at least one plurality of compressed air nozzles and by means of a blowing unit, said nozzles being disposed downstream of an outlet end of said conveyor belt and configured to selectively push downward, by means of compressed air, said materials of organic origin and/or said metallic materials detected by said detection unit under the control of an electronic control unit and said blowing device being configured to blow air toward the wood-based materials coming from said outlet end, which pass above said blowing device by inertia, and to push them beyond a separation element disposed downstream of said blowing device; a step of collecting the materials selected by said nozzles in a collection zone located between said separation element and said blowing device in the proximity of which said nozzles are positioned, which are configured to give said selected materials sufficient inertia to avoid the thrust of said blowing device.
